(19) United States
(12) Patent Application Publication
(10) Pub. No.: US 2003/0110250 A1
(43) Pub. Date: Jun. 12, 2003

(54) Data Normalization

(76) Inventors: Jason K. Schnitzer, Boulder, CO (US); Daniel J. Rice, Windham, NH (US); Robert F. Cruickshank III, Chichester, NY (US); Andrew J. Zajkowski, Nashua, NH (US)

Correspondence Address: MINTZ, LEVIN, COHN, FERRIS,, GLOVSKY and POPEO, P.C., One Financial Center, Boston, MA, 02111, US

(21) Appl. No.: 09/995,058

(22) Filed: Nov. 26, 2001

(51) Int. Cl. G06F 15/173

(52) U.S. Cl. 709/224

(57) ABSTRACT

A system, for use with a broadband network, includes a data collector configured to be coupled to at least a portion of the network and configured to obtain network performance metrics from network elements in the at least a portion of the network, and a data processor configured to process the obtained metrics to yield normalized metrics by adjusting the obtained metrics, as appropriate, such that similar metric types with different values obtained from disparate network elements based upon similar network performance associated with the disparate elements will be normalized to have normalized values that are similar.

### FIELD OF THE INVENTION

The invention relates to normalizing data and more particularly to normalizing broadband network performance metrics produced by disparate network elements.

### BACKGROUND OF THE INVENTION

Communications networks are expanding and becoming faster in response to demand for access by an ever-increasing amount of people and for demand for quicker response times and more data-intensive applications. Examples of such communications networks are for providing computer communications. There are an estimated 53 million dial-up subscribers currently using telephone lines to transmit and receive computer communications. Presently, a multitude of computer users are turning to cable communications. It is estimated that there are 5.5 million users of cable for telecommunications at present, with that number expected to increase rapidly in the next several years.

In addition to cable, there are other currently-used or anticipated broadband communications network technologies, with others as yet to be created sure to follow. Examples of other presently-used or presently-known broadband technologies are: digital subscriber line (DSL) with approximately 3 million subscribers, satellite, fixed wireless, free-space optical, datacasting, and High-Altitude Long Operation (HALO).

Broadband networks currently serve millions of subscribers, with millions more to come. These networks use large numbers of network elements, such as Cable Modem Termination Systems (CMTSs) physically distributed over wide areas, and other network elements, such as Cable Modems (CMs) located, e.g., in subscribers' homes. With so many network elements needed present and future due to so many subscribers present and future, and changing demands on network performance, there is a large market for network elements and thus there are numerous makers of network elements. Different makers often process similar data differently, and even the same maker may process the same data differently with network elements of different configurations, e.g., different models, hardware versions, software versions, and/or element settings.

### SUMMARY OF THE INVENTION

In general, in an aspect, the invention provides a system, for use with a broadband network, that includes a data collector configured to be coupled to at least a portion of the network and configured to obtain network performance metrics from network elements in the at least a portion of the network, and a data processor configured to process the obtained metrics to yield normalized metrics by adjusting the obtained metrics, as appropriate, such that similar metric types with different values obtained from disparate network elements based upon similar network performance associated with the disparate elements will be normalized to have normalized values that are similar.

Implementations of the invention may include one or more of the following features. The processor is configured to adjust each the obtained metrics depending upon device-specific information of each network element. The device-specific information includes at least one of make, model, hardware version, software version, and element settings associated with each of the network elements. The data collector is further configured to obtain at least one of MIB objects and command line interface information from the network elements and the data processor is further configured to determine the device-specific information from the at least one of MIB objects and command line interface information.

Further implementations of the invention may include one or more of the following features. The network performance metrics are remotely-accessible standard management instrumentation. The network is a DOCSIS network and the network performance metrics include at least one of signal-to-noise ratio, power level, equalizer coefficients, settings information, error information, counter information, bandwidth, quality of service, latency, and jitter. At least one of the data collector and the data processor comprise software instructions and a computer processor configured to read and execute the software instructions.

In general, in another aspect, the invention provides a computer program product residing on a computer-readable medium and including computer-executable instructions for causing a computer to obtain network performance metrics from broadband network elements, use network management instrumentation associated with the broadband network elements to determine which of multiple calibration algorithms to apply to the obtained metrics, and normalize the obtained metrics using the determined calibration algorithm to yield normalized metrics by adjusting the obtained metrics, as appropriate, such that a first metric from a first network element and having a first value and a second metric, from a second network element and of a similar type as the first metric, and having a second value, different from the first value, yield first and second normalized metrics having similar values if the first and second metric values are associated with similar network performance at the first and second network elements.

Implementations of the invention may include one or more of the following features. The network management instrumentation includes MIB objects and the instructions for causing the computer to use the network management instrumentation are for causing the computer to identify the first and second network elements using the MIB objects. The instructions for causing the computer to identify the first and second network elements cause the computer to determine at least one of make, model, hardware version, software version, and settings of each of the first and second network elements.

In general, in another aspect, the invention provides a method of calibrating a broadband network performance metric from a first broadband network element configured to determine the performance metric in a way that yields a different value of the metric than another way implemented by a different broadband network element. The method includes obtaining network performance data, determining first values of the network performance metric from the obtained network performance data, obtaining second values of the network performance metric provided by the first broadband network element, the second values being correlated to the first values, and deriving a relationship between the first values and the second values of the network performance metric to convert the first values to the second values.

Implementations of the invention may include one or more of the following features. Obtaining the first values comprises measuring characteristics of the network associated with the first network element, the network is a DOCSIS network, and wherein obtaining the second values comprises polling MIB objects of the first network element. Deriving the relationship comprises curve fitting the first and second values. Deriving the relationship further comprises determining coefficients of a polynomial describing the second values as a function of the first values. The network performance data are obtained corresponding to a range of first values and second values. The method further includes injecting test data into at least a portion of the network associated with the network element to affect the network performance data.

Various aspects of the invention may provide one or more of the following advantages. Performance metrics can be made to be standardized across disparate network elements. Substantially uniform reporting of historical data is possible when comparing network quality based on data from different network elements. Substantially consistent reporting of network exceptions (asynchronous notification of user-specified network state) across network elements of different vendors, hardware, software, and/or settings is possible. It is possible to report network metrics that correlate better to measurements obtained through more accurate physical measurement of the network such as using a spectrum analyzer to measure power or signal-to-noise ratio, or by reading network element documentation regarding make, model, hardware, and software. Vendor-proprietary and/or vendor-specific management features (network information, e.g., that are outside the DOCSIS™ (Data Over Cable Service Interface Specification) standard) may be used in a generic management system, e.g., by processing information from different network element arrangements differently.

These and other advantages of the invention, along with the invention itself, will be more fully understood after a review of the following figures, detailed description, and claims.

### BRIEF DESCRIPTION OF THE FIGURES

FIG. 1 is a simplified diagram of a telecommunications network including a network monitoring system.

FIG. 2 is a block diagram of a software architecture of a portion of the network monitoring system shown in FIG. 1.

FIG. 3 is a simplified block diagram of a calibration arrangement including calibration equipment connected to a portion of the network shown in FIG. 1.

FIG. 4 is a block flow diagram of a process of calibrating network elements.

FIG. 5 is a block flow diagram of a process of normalizing network performance metrics.

FIG. 6 is a block flow diagram of another process of calibrating network elements.

### DETAILED DESCRIPTION OF PREFERRED EMBODIMENTS

The invention provides techniques for calibrating and normalizing monitoring data in networks, especially DOCSIS networks. For DOCSIS networks, Management Information Base (MIB) objects (management instrumentation) are analyzed to determine relevant attributes (e.g., make, model, hardware version, software version, network element settings (e.g., amount of error correction) of a network element such as a CMTS or CM. Knowing the relevant attributes for the network element, a corresponding predetermined normalization algorithm is applied to convert a performance metric (i.e., measurements of network performance based on raw data), determined by the element from monitored data, into a normalized metric. The normalization compensates for different techniques used by different element configurations to determine the same metric. The normalization uses calibration information that may be obtained by testing elements of various makes, models, hardware versions, software versions, and settings. Test results are analyzed to determine how similar metrics determined by the tested elements from similar monitored data should be converted to yield similar normalized metric values. Value in this context can be quantity information (e.g., numeric, magnitude value), and/or format information (e.g., how the information is arranged). Determining how the data should be converted yields the calibration information. Calibration information may also be obtained using knowledge of calibration information from one or more network elements and one or more relationships between how metrics are calculated by the network elements for which calibration information is known and by the element for which calibration information is to be obtained.

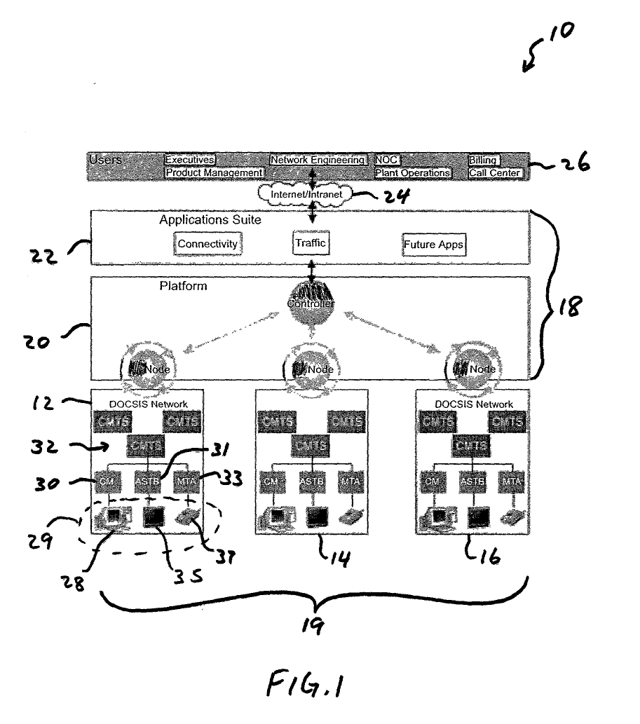

Referring to FIG. 1, telecommunication system 10 includes DOCSIS (data over cable service interface specification) networks 12, 14, 16, a network monitoring system 18 that includes a platform 20 and an applications suite 22, a packetized data communication network 24 such as an intranet or the global packet-switched network known as the Internet, and network monitors/users 26. The networks 12, 14, 16 are configured similarly, with the network 12 including CMTSs 32 and consumer premise equipment (CPE) 29 including inter alia a cable modem (CM) 30, an advanced set-top box (ASTB) 31, and a multi-media terminal adaptor (MTA) 33. The CPE 29 could include other devices such as home gateways, with the devices shown being exemplary only, and not limiting Users of the DOCSIS networks 12, 14, 16, communicate, e.g., through the computer 28 and the cable modem (CM) 30 (or through a monitor 35 and the ASTB 31, or through a multi-media terminal 37 and the MTA 33) to one of the multiple CMTSs 32.

Data relating to operation of the network 12 are collected by nodes 34, 36, 38. The data include data regarding operation of the CMTSs 32, the CM 30, the ASTB 31, the MTA 33, and the CPE 29 (here the computer 28, the monitor 35, and the terminal 37). The nodes 34, 36, 38 can communicate bi-directionally with the networks 12, 14, 16 and that manipulate the collected data to determine metrics of network performance (including network element state). These metrics can be forwarded, with or without being combined in various ways, to a controller 40 within the platform 20.

The controller 40 provides a centralized access/interface to network elements and data, applications, and system administration tasks such as network configuration, user access, and software upgrades. The controller can communicate bi-directionally with the nodes 34,36, 38, and with the applications suite 22. The controller 40 can provide information relating to performance of the networks 12, 14, 16 to the application suite 22.

The application suite 22 is configured to manipulate data relating to network performance and provide data regarding the network performance in a user-friendly format through the network 24 to the network monitors 26. The monitors 26 can be, e.g., executives, product managers, network engineers, plant operations personnel, billing personnel, call center personnel, or Network Operations Center (NOC) personnel.

The system 18, including the platform 20 and the application suite 22, is preferably comprised of software instructions in a computer-readable and computer-executable format that are designed to control a computer. The software can be written in any of a variety of programming languages such as C++. Due to the nature of software, however, the system 18 may comprise software (in one or more software languages), hardware, firmware, hard wiring or combinations of any of these to provide functionality as described above and below. Software instructions comprising the system 18 may be provided on a variety of storage media including, but not limited to, compact discs, floppy discs, read-only memory, random-access memory, zip drives, hard drives, and any other storage media for storing computer software instructions.

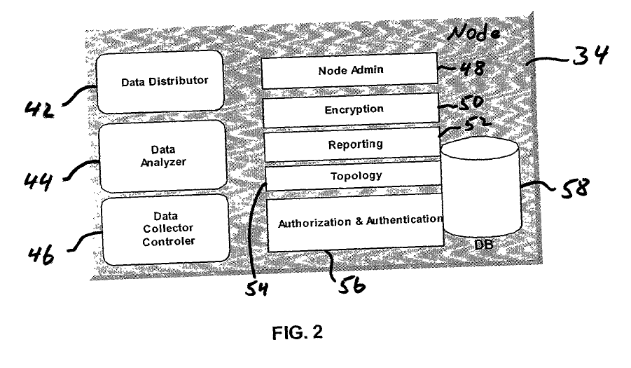

Referring also to FIG. 2, the node 34 (with other nodes 36, 38 configured similarly) includes a data distributor 42, a data analyzer 44, a data collector controller 46, a node administrator 48, an encryption module 50, a reporting module 52, a topology module 54, an authorization and authentication module 56, and a database 58. The elements 44, 46, 48, 50, 52, 54, and 56 are software modules designed to be used in conjunction with the database 58 to process information through the node 34. The node administration module 48 provides for remote administration of node component services such as starting, stopping, configuring, status monitoring, and upgrading node component services. The encryption module 50 provides encrypting and decrypting services for data passing through the node 34. The reporting module 52 is configured to provide answers to data queries regarding data stored in the database 58, or other storage areas such as databases located throughout the system 18. The topology module 54 provides for management of network topology including location of nodes, network elements, and high-frequency coax (HFC) node combining plans. Management includes tracking topology to provide data regarding the network 12 for use in operating the network 12 (e.g., how many of what type of network elements exist and their relationships to each other). The authorization and authentication module 56 enforces access control lists regarding who has access to a network, and confirms that persons attempting to access the system 18 are who they claim to be. The data distributor 42, e.g., a publish-subscribe bus implemented in JMS, propagates information from the data analyzer 44 and data collector controller 46, that collect and analyze data regarding network performance from the CMTSs 32 and CPE 30, 31, 33.

The data collector controller 46 is configured to collect network data from, preferably all elements of, the network 12, and in particular the network elements such as the CMTSs 32 and any cable modems such as the cable modem 30. The controller 46 is configured to connect to network elements in the network 12 and to control the configuration to help optimize the network 12. Thus, the system 18 can automatically adjust error correction and other parameters that affect performance to improve performance based on network conditions. The data collector controller 46 can obtain data from the network 12 synchronously, by polling devices on the network 12, or asynchronously. The configuration of the controller 46 defines which devices in the network 12 are polled, what data are collected, and what mechanisms of data collection are used. The controller 46 is configured to use SNMP MIB (Simple Network Management Protocol Management Information Base) objects for both cable modems and CMTSs, CM traps and CMTS traps (that provide asynchronous information) and syslog files. The collector 46 synchronously obtains data periodically according to predetermined desired time intervals in accordance with what features of the network activity are reflected by the corresponding data. Whether asynchronous or synchronous, the data obtained by the controller 46 is real-time or near real-time raw data concerning various network performance characteristics of the network 12. For example, the raw data may be indicative of signal to noise ratio (SNR), power, CMTS resets, equalizer coefficients, settings information, error information, counter information, bandwidth, quality of service, latency, and/or jitter, etc. The controller 46 is configured to pass the collected raw data to the data analyzer 44 for further processing.

The data analyzer 44 is configured to accept raw data collected by the controller 46 and to manipulate the raw data into metrics indicative of network performance. Raw data from which values of the network performance metrics are determined may be discarded.

The metrics are standardized/normalized to compensate for different techniques for determining/providing raw network data from various network element configurations, e.g., from different network element manufacturers. For example, two network elements made by different manufacturers, or two network elements made by the same manufacturer but having different hardware, software, and/or element settings may determine raw data, e.g., SNR, differently. The different devices may therefore report different raw data values for the same characteristic in response to the same input data. To help provide meaningful data for large networks that include different element attributes, the data analyzer 44 can normalize raw data values from various elements so that for the same reported characteristic from two network elements, the normalized values will be approximately, if not exactly, the same for the same input data applied to the two network elements.

The node 34 is further configured to use MIB objects to identify the attributes of network elements to determine how to normalize data from the elements. The node 34 can analyze MIB objects to determine a network device's make, model, software version, hardware version, and settings (and any other trait to be used to determine which normalization algorithm to use). Based on the identity of the network element, the node 34 selects a predetermined normalizing algorithm to be applied to the particular data, with algorithms being tailored to the device attributes and to the particular data, e.g., SNR versus power. The algorithms are stored in, or associated with, the node 34 and are determined by calibration equipment.

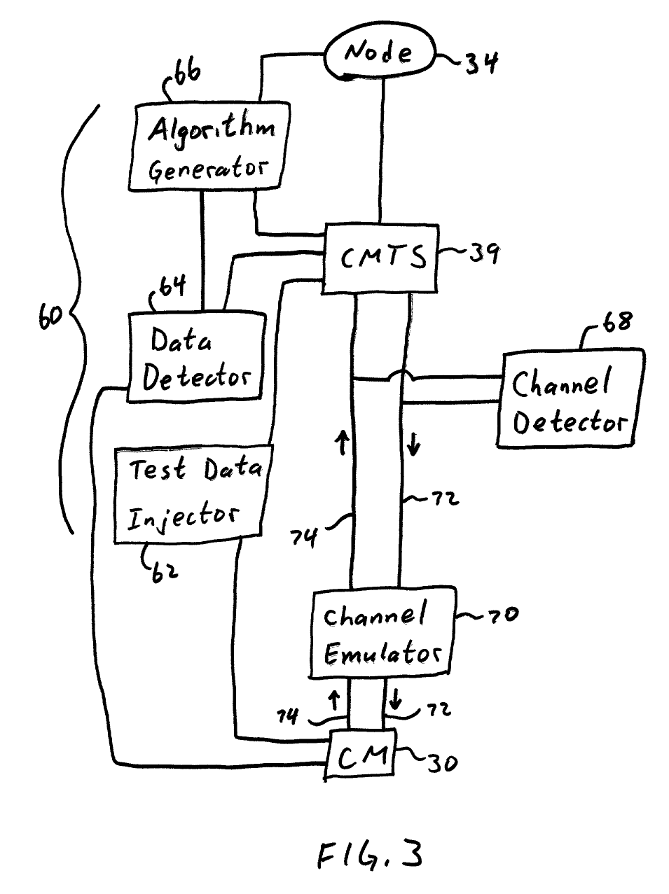

Referring to FIGS. 1 and 3, calibration equipment 60 includes a test data injector 62, a data detector 64, an algorithm generator 66, a channel detector 68, and a channel emulator 70. Although the devices 62, 64, 66, 68, 70 are shown separate, these devices may be incorporated into fewer devices, e.g., a single device, or more devices. The channel emulator 70 is configured to emulate channel conditions (e.g., signal quality) of a network distribution for a CMTS 39 from the set 32 of CMTSs and the CM 30. The emulator 70 can be, e.g., a TAS 8250 made by Spirent plc of West Sussex, United Kingdom. The channel detector 68 is configured to read signal quality on the channels 72, 74 and report this information, e.g., to a user (not shown). The channel detector 68 can be, e.g., a Vector Signal Analyzer made by Agilent Technologies of Palo Alto, Calif. The injector 62 is configured to inject test data, e.g., impairments such as noise, into a downstream channel 72 and/or an upstream channel 74 between the CM 30 and a CMTS 39 from the set 32 of CMTSs. The data detector 64 is configured to detect packetized data on the channels 72, 74 and provide these data to the algorithm generator 66.

The algorithm generator 66 is configured to receive the detected data from the detector 64 and MIB-reported data from the CMTS 39, and to analyze these data to determine algorithms relating actual channel characteristics to MIB-reported characteristics. The analysis may be, e.g., curve fitting data points of measured data and output MIB-reported data to derive functions describing the actual to MIB-reported data relationship. For example, second order, third degree, polynomials may be derived to express channel noise ratio (CNR) as a function of SNR, where SNR is an unmodulated signal inside a network element and CNR is a modulated signal outside a network element. These polynomials provide conversion algorithms and can be stored by the generator 66 in a storage area accessible by the node 34 (e.g., in the node 34). The stored algorithms are stored in association with the network element attributes, such that they are accessible by the node 34 using the network element attributes. Other techniques for normalization include a combination of curve fitting and using other MIB objects that can be used to derive the status of the normalized MIB objects. For example, SNR can be inferred by curve fitting and using known influences a variety of other MIB objects including codeword errors, power levels, equalizer settings, and packet size distributions. For example, the results from curve fitting may be modified given knowledge of effects of other MIB objects on, e.g, SNR. Additionally, mathematical techniques that are more complex than curve fitting could be used.

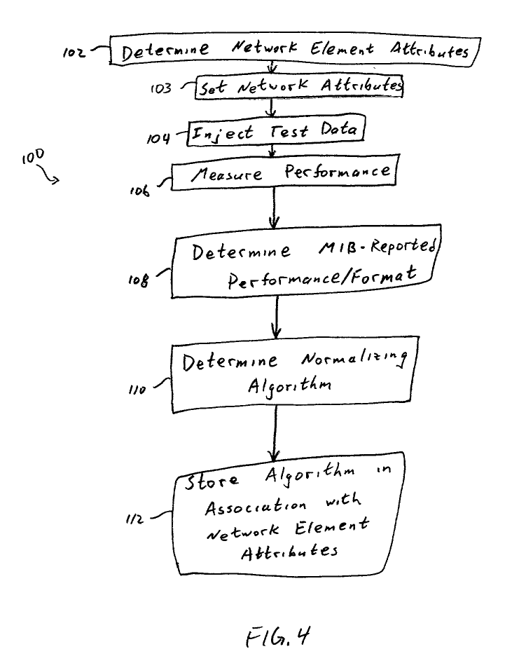

In operation, referring to FIG. 4, with further reference to FIGS. 1-3, a process 100 for calibrating network elements to determine calibration information using the node 34 includes the stages shown. The process 100, however, is exemplary only and not limiting. The process 100 can be altered, e.g., by having stages added, removed, or rearranged. The calibrating process 100 standardizes network elements by determining deviations from a standard to ascertain correction factors.

At stage 102, the node 34 determines network element attributes. The network elements, e.g., the attributes of the CMTSs 32 and/or the CM 30 are determined by analyzing appropriate MIB objects. For example, for a DOCSIS network, the enterprise-specific System Object Idententifier from the system group of IETF MIB-II (RFC-1213):

sysObjectID OBJECT-TYPE

SYNTAX OBJECT IDENTIFIER

ACCESS read-only

STATUS mandatory

DESCRIPTION

“The vendor's authoritative identification of the network management subsystem contained in the entity. This value is allocated within the SMI enterprises subtree (1.3.6.1.4.1) and provides an easy and unambiguous means for determining ‘what kind of box’ is being managed. For example, if vendor ‘Flintstones, Inc.’ was assigned the subtree 1.3.6.1.4.1.4242, it could assign the identifier 1.3.6.1.4.1.4242.1.1 to its ‘Fred Router’.”

{system 2}

All DOCSIS devices implement the sysObjectID MIB object. Examples of how to describe each device in terms of its sysObjectID and how to map the device to a normalization function are included in Appendix A. Each of these examples provide what is referred to as a Normalization File. Other ways to identify element information are acceptable, such as using sysdescription MIBs, that report software version.

At stage 103, network attributes are set. The test data injector 62 is set to inject desired data and the channel emulator 70 is set to provide desired network-emulating data (e.g., noise, RF parameters such as delay and microreflections).

At stage 104, the test data injector 62 injects appropriate test data into the upstream line 70 and/or the downstream line 68. The injector 62 introduces impairments (noise) in the appropriate channel(s) 68, 70 for processing and reporting by the network elements 30, 39. The injector 62 may not inject test data if non-performance data are to be determined and normalized.

At stage 106, the network performance in response to the introduced noise is measured. The data detector 64 determines actual network performance, e.g. CNR, on the channel(s) 68, 70. If no test data are injected by the test data injector 62, the detector 64 detects non-performance information, such as format information (that is often vendor-specific), for metrics. For example, system description (e.g., indicating hardware and software versions) often varies in format between network element vendors. The detector 64 provides the detected data to the algorithm generator 66.

At stage 108, the algorithm generator 66 obtains MIB-reported performance. The network elements 30, 39 provide MIB objects indicative of network performance, with these objects typically indicating different values than those detected by the detector 64. Examples of MIB objects for various performance metrics are provided below. These examples are for MIB-based SNR readings in a DOCSIS network, and are exemplary only and not limiting of the invention.

CM Downstream SNR

CM downstream SNR is available for the CM's downstream interface in the CM docsIfSignalQualityTable via object docsIfSigQSignalNoise. The following MIB object is used from IETF RFC-2670 to report downstream channel SNR for the downstream interface on a CM.

docsIfSigQSignalNoise OBJECT-TYPE

SYNTAX TenthdB
UNITS “dB”
MAX-ACCESS read-only
STATUS current
DESCRIPTION

“Signal/Noise ratio as perceived for this channel.
At the CM, describes the Signal/Noise of the downstream
channel. At the CMTS, describes the average Signal/Noise
of the upstream channel.”

REFERENCE

“DOCSIS Radio Frequency Interface specification,
Table 2-1 and 2-2”

::= { docsIfSignalQualityEntry 5 }

CMTS per Upstream Channel SNR

CMTS per upstream channel SNR is found in the docsIfSignalQualityTable for each upstream interface instance attached to the CMTS reported via object docsIfSigQSignalNoise. The following MIB object is used from IETF RFC-2670 to report upstream channel SNR for each upstream interface on a CMTS:

docsIfSigQSignalNoise OBJECT-TYPE

SYNTAX TenthdB
UNITS “dB”
MAX-ACCESS read-only
STATUS current
DESCRIPTION

“Signal/Noise ratio as perceived for this channel.
At the CM, describes the Signal/Noise of the downstream

channel. At the CMTS, describes the average

Signal/Noise of the upstream channel.”

REFERENCE

“DOCSIS Radio Frequency Interface specification,
Table 2-1 and 2-2”

::= { docsIfSignalQualityEntry 5 }

CMTS per CM Upstream SNR

CMTS per CM upstream SNR differs from the channel SNR measurement described above. CMTS per CM upstream SNR is a measurement made and reported for each CM attached to the CMTS in the docslfCmtsCmStatusTable using the object docslfCmtsCmStatusSignalNoise. The following MIB object is used from IETF RFC-2670 to report upstream channel SNR per CM for each CM on a CMTS:

docsIfCmtsCmStatusSignalNoise OBJECT-TYPE

SYNTAX TenthdB
UNITS “dB”
MAX-ACCESS read-only
STATUS current
DESCRIPTION

“Signal/Noise ratio as perceived for upstream data from
this Cable Modem.
If the Signal/Noise is unknown, this object returns
a value of zero.”

::= { docsIfCmtsCmStatusEntry 13 }

At stage 110, the algorithm generator 66 analyzes the measured actual performance data detected by the detector 64 and the MIB-reported data from the CMTS 39, and determines a normalizing algorithm. The generator 66 analyzes associated data 10 (associated in time of measurement and MIB-reporting) by curve fitting the data, that may be arranged in a table such as Table 1 provided below for CM Downstream SNR vs. CNR. Examples of algorithm determinations are provided below.

CM Downstream SNR

TABLE 1
Hypothetical Measured Downstream Channel CNR vs. SNR
(docsIfSigQSignalNoise)

| SNR | CNR |
|---|---|
| (MIB) | (Actual) |
| 35.2 | 35 |
| 35.1 | 34 |
| 35.1 | 33 |
| 34.9 | 32 |
| 33 | 31 |
| 33 | 30 |
| 33 | 29 |
| 32.8 | 28 |
| 31.3 | 27 |
| 31.3 | 26 |
| 29.8 | 25 |
| 29.5 | 24 |
| 28.6 | 23 |
| 28.3 | 22 |
| 27.6 | 21 |
| 26.4 | 20 |
| 25.5 | 19 |
| 24.6 | 18 |
| 24 | 17.5 |
| 23.5 | 17 |
| 22.9 | 16.5 |
| 22.2 | 16 |
| 21.8 | 15.5 |
| 21.5 | 15 |
| 20.8 | 14.5 |
| 20 | 14 |
| 19 | 13.5 |
| 19 | 13 |
| 19 | 12.5 |
| 18 | 12 |
| 17 | 11.5 |
| 16.9 | 11 |
| 15.5 | 10.5 |
| 15.5 | 10 |
| 13.9 | 9.5 |

A second order polynomial (3^{rd} degree) can be used to fit this curve. In general form, the polynomial is:

CNR=a3*SNR³+a2*SNR²+a1* SNR+a0

In the case of the example calibration data provided in Table 1, the normalization polynomial coefficients for Vendor X, and attributes i (with vendor being an attribute), would be:

a3=0.0011, a2=−0.0499, a1=1.5047, a0=−5.0566

With the results of this calibration available a normalization function can be defined for vendor X, and attributes i:

CNR=f_{vendorX-i}(SNR)

In this way, a normalization function can be defined for all CM vendors. An algorithm could be applied to each CM that returns a poll.

For each CM {

Identify CM attributes (vendorx₁)
cnr = snrtocnr(vendorxᵢ, docsIfSigQSignalNoise)

}

CMTS per Upstream Channel SNR

A table similar to Table 1 would result. With the results of this calibration available a normalization function can be defined for CMTS vendor X, and attributes i:

CNR=f_{vendorX-i}(SNR)

In this way, a normalization function can be defined for all CMTS vendors. An algorithm could be applied to each CMTS that returns a poll.

Identify CMTS attributes (vendorxᵢ)
For each CMTS upstream interface {

cnr = snrtocnr(vendorxᵢ, docsIfSigQSignalNoise)

}

CMTS per CM Upstream SNR

A table similar to the one described in FIG. 2 would result. With the results of this calibration available a normalization function can be defined for CMTS vendor X, and attributes i:

CNR=f_{vendorX-i}(SNR)

In this way, a normalization function can be defined for all CMTS vendors. An algorithm could be applied to each CMTS that returns a poll.

Identify CMTS attributes (vendorx₁)
For each CM in the CmtsCmStatusTable {

cnr = snrtocnr(vendorx₁, docsIfCmtsCmStatusSignalNoise)

}

At stage 112, the determined algorithms are stored by the algorithm generator 66. The generator 66 stores the algorithm(s) in association with the attributes of the network element associated with the algorithm such that the node 34 can retrieve the appropriate algorithm using attribute information. The algorithm can be stored in the node 34, or elsewhere, such as a database, that is accessible by the node 34.

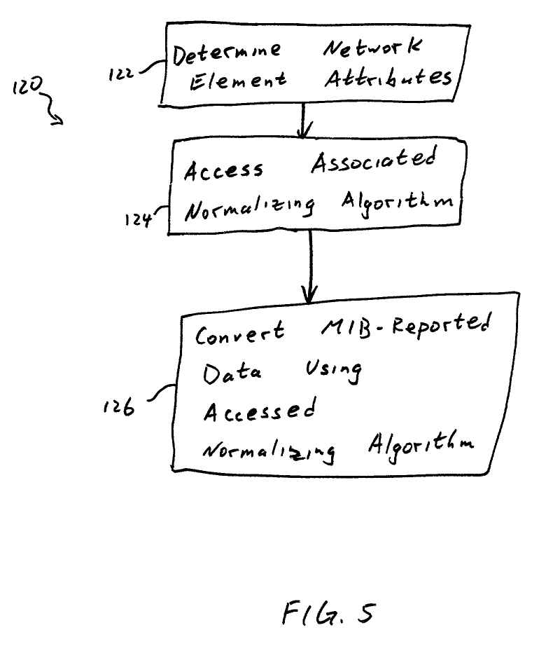

Referring to FIG. 5, with further reference to FIGS. 1-3, a process 120 for normalizing network performance metrics using the node 34 includes the stages shown. The process 120, however, is exemplary only and not limiting. The process 120 can be altered, e.g., by having stages added, removed, or rearranged.

At stage 122, the node 34 determines network element attributes. The network elements, e.g., the attributes of the CMTSs 32 and/or the CM 30 are determined by analyzing appropriate MIB objects.

At stage 124, the node 34 uses the determined network attributes to access an appropriate normalizing algorithm. The node 34 searches the appropriate storage area where algorithms are stored, and retrieves the algorithm associated with the determined attributes. If no stored algorithm is associated with the determined attributes, then the raw MIB-reported data from the network element are returned untreated and included with the corrected data in any subsequent calculations. More than one set of attributes may be associated with a single algorithm, e.g., if a metric of interest is calculated the same by elements having different attribute sets.

At stage 126, the node 34 applies the normalizing algorithm to normalize the MIB-reported data from the network element (e.g., CMTS 39, CM 30). The resulting normalized metric(s) may be passed by the node 34 to other portions of the system 10 for further processing, e.g., to reflect network performance for the users 26 as described in co-filed applications entitled “NETWORK PERFORMANCE MONITORING,” U.S. Ser. No. (to be determined), “NETWORK PERFORMANCE DETERMINING,” U.S. Ser. No. (to be determined), and “NETWORK PERFORMANCE PARAMETERIZING,” U.S. Ser. No. (to be determined), each of which is incorporated here by reference.

Other embodiments are within the scope and spirit of the appended claims. For example, due to the nature of software, functions described above can be implemented using software, hardware, firmware, hardwiring, or combinations of any of these. Features implementing functions may also be physically located at various positions, including being distributed such that portions of functions are implemented at different physical locations. Other MIB objects and network performance metrics than those listed may be used. Further, network element configuration may be obtained using techniques other than obtaining MIB objects. For example, a command line interface (cli) may be used to determine element configuration. The standard to which metrics are normalized may be different than a measured-data standard. Also, a normalized metric may be the same as an un-normalized metric if the un-normalized metric is the standard.

The invention is particularly useful with DOCSIS networks. The DOCSIS 1.1 specifications SP-BPI+, SP-CMCI, SP-OSSIv1.1, SP-RFIv1.1, BPI ATP, CMCI ATP, OSS ATP, RFI ATP, and SP-PICS, and DOCSIS 1.0 specifications SP-BPI, SP-CMTRI, SP-CMCI, SP-CMTS-NSI, SP-OSSI, SP-OSSI-RF, SP-OSSI-TR, SP-OSSI-BPI, SP-RFI, TP-ATP, and SP-PICS are incorporated here by reference. The invention, as embodied in the claims, however, is not limited to these specifications, it being contemplated that the invention embodied in the claims is useful for/with, and the claims cover, other networks/standards such as DOCSIS 2.0, due to be released in December, 2001.

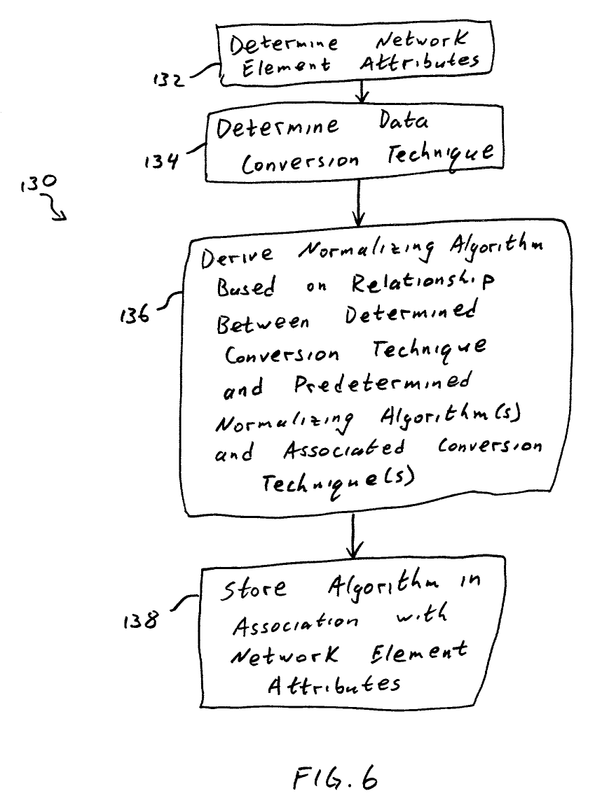

Also, referring to FIG. 6, process 130 for calibrating network elements may be used. The process 130 uses the node 34 and includes the stages shown. The process 130, however, is exemplary only and not limiting. The process 130 can be altered, e.g., by having stages added, removed, or rearranged. At stage 132, the node determines the network element attributes as described above (see stage 102 of process 100). At stage 134, the node, e.g., using MIB objects and knowledge of attributes and associated conversion techniques, determines a conversion technique for converting raw data to MIB-reported data for a metric of interest by the network element of interest. At stage 136, the node 34 derives a normalizing algorithm for the element of interest. The derivation is based on knowledge of the conversion technique used by the element of interest, based on knowledge of one or more normalizing algorithms associated with one or more other conversion techniques. The derivation is also based on knowledge of those one or more other conversion techniques and/or their relationships to the conversion technique used by the element of interest. At stage 128, the derived algorithm is stored in association with the element's attributes.

Also, while the description above focused on normalizing network performance metrics (e.g., FIG. 5 and related discussion), normalization may be applied to numerous types of network-element information including, but not limited to, performance metrics, other metrics, and format of network-element-reported data (e.g., hardware and software version).

[image]

What is claimed is:

1. A system for use with a broadband network, the system comprising:
a data collector configured to be coupled to at least a portion of the network and configured to obtain network performance metrics from network elements in the at least a portion of the network; and
a data processor configured to process the obtained metrics to yield normalized metrics by adjusting the obtained metrics, as appropriate, such that similar metric types with different values obtained from disparate network elements based upon similar network performance associated with the disparate elements will be normalized to have normalized values that are similar.

2. The system of claim 1 wherein the processor is configured to adjust each of the obtained metrics depending upon device-specific information of each network element.

3. The system of claim 2 wherein the device-specific information includes at least one of make, model, hardware version, software version, and element settings associated with each of the network elements.

4. The system of claim 2 wherein the data collector is further configured to obtain at least one of MIB objects and command line interface information from the network elements and the data processor is further configured to determine the device-specific information from the at least one of MIB objects and command line interface information.

5. The system of claim 1 wherein the network performance metrics are remotely-accessible standard management instrumentation.

6. The system of claim 5 wherein the network is a DOCSIS network and the network performance metrics include at least one of signal-to-noise ratio, power level, equalizer coefficients, settings information, error information, counter information, bandwidth, quality of service, latency, and jitter.

7. The system of claim 1 wherein at least one of the data collector and the data processor comprise software instructions and a computer processor configured to read and execute the software instructions.

8. A computer program product residing on a computer-readable medium and including computer-executable instructions for causing a computer to:
obtain network performance metrics from broadband network elements;
use network management instrumentation associated with the broadband network elements to determine which of multiple calibration algorithms to apply to the obtained metrics; and
normalize the obtained metrics using the determined calibration algorithm to yield normalized metrics by adjusting the obtained metrics, as appropriate, such that a first metric from a first network element and having a first value and a second metric, from a second network element and of a similar type as the first metric, and having a second value, different from the first value, yield first and second normalized metrics having similar values, if the first and second metric values are associated with similar network performance at the first and second network elements.

9. The computer program product of claim 8 wherein the network management instrumentation includes MIB objects and the instructions for causing the computer to use the network management instrumentation are for causing the computer to identify the first and second network elements using the MIB objects.

10. The computer program product of claim 9 wherein the instructions for causing the computer to identify the first and second network elements cause the computer to determine at least one of make, model, hardware version, software version, and settings of each of the first and second network elements.

11. A method of calibrating a broadband network performance metric from a first broadband network element configured to determine the performance metric in a way that yields a different value of the metric than another way implemented by a different broadband network element, the method comprising:
obtaining network performance data;
determining first values of the network performance metric from the obtained network performance data;
obtaining second values of the network performance metric provided by the first broadband network element, the second values being correlated to the first values; and
deriving a relationship between the first values and the second values of the network performance metric to convert the first values to the second values.

12. The method of claim 11 wherein obtaining the first values comprises measuring characteristics of the network associated with the first network element, the network is a DOCSIS network, and wherein obtaining the second values comprises polling MIB objects of the first network element.

13. The method of claim 12 wherein deriving the relationship comprises curve fitting the first and second values.

14. The method of claim 13 wherein deriving the relationship further comprises determining coefficients of a polynomial describing the second values as a function of the first values.

15. The method of claim 11 wherein the network performance data are obtained corresponding to a range of first values and second values.

16. The method of claim 11 further comprising injecting test data into at least a portion of the network associated with the network element to affect the network performance data.
